(19) United States
(12) Patent Application Publication
(10) Pub. No.: US 2023/0413176 A1
(43) Pub. Date: Dec. 21, 2023

(54) DECLARATION OF LOW LATENCY RELIABLE SERVICE IN A BSS

(71) Applicant: CANON KABUSHIKI KAISHA, Tokyo (JP)

(72) Inventors: Patrice NEZOU, Liffre (FR); Stéphane BARON, Le Rheu (FR); Pascal VIGER, Janze (FR)

(21) Appl. No.: 18/249,152

(22) PCT Filed: Oct. 19, 2021
(86) PCT No.: PCT/EP2021/078867

§ 371 Date: Apr. 14, 2023

(30) Foreign Application Priority Data
Oct. 20, 2020 (GB) 2016655.9
Sep. 24, 2021 (GB) 2113691.6

(51) Int. Cl. H04W 52/02; H04W 74/08; H04W 60/00

(52) U.S. Cl. CPC H04W 52/0216; H04W 74/0866; H04W 60/00

(57) ABSTRACT

According to an aspect of the invention, there is a proposed a frame for advertising a Target Wake Time, TWT, service period designed to be sent by an access point, AP, of a first Basic Service Set, BSS, to one or more stations of the BSS, the frame including a field, wherein the field indicates whether the TWT service period is dedicated for low-latency traffic transmission. According to other aspects of the invention, there is a proposed a method and an apparatus for generating and transmitting the above defined advertisement frame.

### FIELD OF THE INVENTION

The present invention generally relates to wireless communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE®) provides a great number of mechanisms for wireless communications between stations.

With the development of latency sensitive applications such as online gaming, real-time video streaming, virtual reality, drone or robot remote controlling, new low latency and robustness requirements and issues need to be taken into consideration. For instance, 99.9% of latency sensitive packets should be delivered to the end equipment within a 2 ms latency.

These requirements and issues are currently under consideration by the IEEE 802.11 working group as a main objective to issue the next major 802.11 release, known as 802.11 be or EHT for “Extremely High Throughput”.

Low latency reliable services, LLRS, have been defined as targets of such main objective. LLRS are services provided for transporting a higher layer traffic stream that prioritize and deliver MSDUs (data units) within a worst-case latency budget with a given reliability/packet delivery ratio (PDR) and/or low jitter.

An efficient QoS (Quality of Service) management in a BSS (Basic Service Set) is needed to provide low latency, LL, reliable services.

### SUMMARY OF INVENTION

One key issue for an efficient LLRS management in a BSS is for the AP to apply measures to guarantee timely LLRS traffic transmission while keeping implementation cost low and ensuring backward compatibility with legacy devices.

The present invention proposes according to embodiments to adapt the TWT scheme for an efficient management of LLRS traffic within the BSS.

According to an aspect of the invention, there is a proposed a frame for advertising a Target Wake Time, TWT, service period designed to be sent by an access point, AP, of a first Basic Service Set, BSS, to one or more stations of the BSS, the frame including a field, wherein the field indicates whether the TWT service period is dedicated for low-latency traffic transmission.

In one implementation, the field restricts the TWT service period to only low-latency traffic transmission.

In a variant implementation, the field recommends the use of low-latency traffic (without limiting to only such traffic) for transmission during the TWT service period.

According to other aspects of the invention, there is a proposed a method for wireless communications comprising, at a station:

registering the station with an access point, AP, for transmitting frames during a Target Wake Time, TWT, service period setup between the station and the AP;

receiving, from the AP, an advertisement frame announcing the TWT service period; and

transmitting a frame in the TWT service period, wherein the frame comprises in priority a type of traffic specified during the setup of the TWT service period.

The method thus ensures that the traffic with the specified type is transmitted while fulfilling the associated timing constraints.

Advantageously, the frame comprising the specified type of traffic is generated for transmission if the expected transmission time overlaps with the TWT service period. Overlapping with the TWT service period may comprise: 1) transmission time starts within the TWT SP and ends after the end of the TWT SP; 2) transmission time starts and ends within the TWT SP (i.e. the TWT SP encompasses the transmission duration); 3) transmission time starts prior the start of the TWT SP and ends within the TWT SP; or 4) transmission time starts prior the start of the TWT SP and ends after the end of the TWT SP (i.e. the transmission duration encompasses the TWT SP).

Advantageously, following the registering, the station does not set its Network Allocator Vector, NAV, during the service period for enabling the transmission or the reception of frames during the TWT service period.

In an implementation, the method further comprising receiving, from the AP, a trigger frame allocating a resource unit, RU, within the TWT service period for the station to send the frame. The trigger frame reserves a transmission opportunity, TXOP, overlapping or encompassing the TWT service period. The TXOP may advantageously protect the TWT SP from transmissions originating from not registered stations or from legacy stations.

According to embodiments of the invention, the specified traffic type is low latency, LL, traffic. The LL traffic may include for example one or more of time-sensitive traffic and latency-sensitive traffic.

In an implementation, the transmitted frame further comprises other types of traffic, for example after no pending traffic of the specified type is available for sending because previously transmitted or already included in the current frame. These other types of traffic may comprise at least one of the following:

low-latency traffic not specified during the setup of the TWT service period;

traffic type corresponding to a preferred access category, AC, indicated in a trigger frame allocating a resource unit, RU, within the TWT service period for the station to transmit the frame; or

traffic type corresponding to any AC.

In an implementation, the method further comprising contending for access to a communication channel in the TWT service period in order to transmit the frame. This may be advantageous if channel resources are available during the TWT SP without being reserved by the AP (e.g. by means of a trigger frame) or other stations.

The contending may use an enhanced distributed channel access, EDCA, mechanism based on EDCA parameters. The EDCA parameters are set to first values (e.g. values adapted to give priority to the AP or to registered STAs for access the communication channel), different from second values (e.g. default values) that may be used for contending for access outside the service period.

In an implementation, the advertisement frame announcing the service period includes a field that specifies the type of traffic to be used in priority during the TWT service period.

In an implementation, the advertisement frame announcing the service period includes timing information identifying the TWT service period.

The advertisement frame announcing the service period may be a management frame, such as a beacon frame or a probe response frame.

According to implementations, the TWT service period is an individual TWT negotiated between the station and the AP, or a broadcast TWT advertised by the AP.

According to other aspects of the invention, there is a proposed a method and an apparatus for generating and transmitting a frame as defined above.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a network environment in which embodiments of the invention may be implemented;

FIG. 2a shows a schematic representation a communication device in accordance with embodiments of the present invention;

FIG. 2b shows a schematic representation of a wireless communication device in accordance with embodiments of the present invention;

FIG. 3 illustrates signalling implementations for advertising a new low-latency TWT service period in a management frame such as a beacon frame or a probe response frame;

FIG. 4 illustrates an exemplary scenario describing how a low latency TWT service period is executed;

FIG. 5 illustrates a secondary exemplary scenario describing how a low latency TWT service period is executed;

FIGS. 6a and 6b illustrate, using a flowchart, general steps at an AP station according to embodiments of the invention; and

FIGS. 7a and 7b illustrate, using a flowchart, general steps at a non-AP station according to embodiments of the invention.

FIG. 8 illustrates, using a flowchart, general steps at a non-AP station according to embodiments of the invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (referred to herein as AP) or not (referred to herein as non-AP station or STA).

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSSs (and thus corresponding WLANs): each BSS is thus uniquely identified by a specific basic service set identification, BSSID, and managed by a separate virtual AP implemented in the physical AP.

Low latency reliable services, LLRS, are services provided for transporting a higher layer traffic stream that prioritize and deliver MSDUs (data units of this traffic stream) within a worst-case latency budget with a given reliability/packet delivery ratio (PDR) and/or low jitter. Traffic that may be concerned by LLRS may include latency-sensitive data, i.e. data from applications such as gaming, media streaming, augmented reality, virtual reality, and so on. Traffic that may be concerned by LLRS may include time-sensitive data, i.e. jitter-sensitive data, for which timely delivery of data packet is important. Traffic concerned by LLRS, either latency-sensitive and/or time-sensitive, is referred to herein as LLRS traffic or expressed simply as low latency traffic.

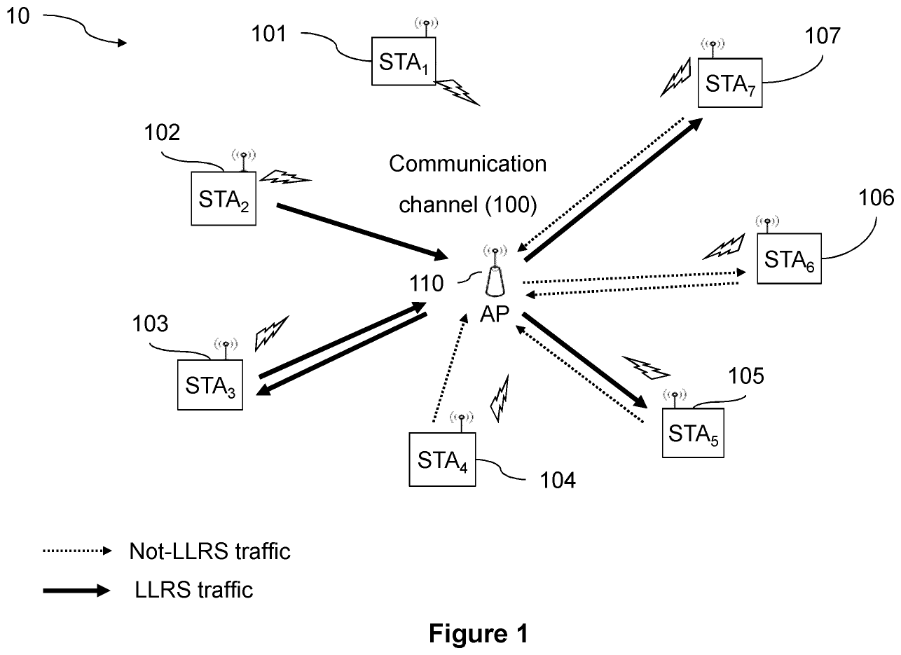

FIG. 1 illustrates an exemplary network environment 10 for delivering LLRS traffic.

Each communication station 101-107 registers to a central station or access point (AP) 110 during an association procedure where the AP assigns a specific Association IDentifier (AID) to the requesting non-AP station. For example, the AID, e.g. a 16-bit value uniquely identifying the non-AP station, is used to identify the stations in the frame exchanged. The AP 110 and the associated non-AP stations 101-107 may represent a basic service set (BSS) or an extended service set (ESS).

Once associated with the BSS, the communication stations 101-107, 110 exchange data frames over a communication channel 100 of a wireless local area network (WLAN), under the management of the AP 110. The communication channel 100 (or radio medium) is defined by an operating frequency band constituted by a single channel or a plurality of channels forming a composite channel.

Non-AP stations may also communicate directly via a direct wireless link (DiL for direct link), i.e. without the intervention of the AP as a relay of data frames. Exemplary situation of direct communications includes the presence of peer-to-peer (P2P) communications between non-AP stations having the same primary channel.

The stations 101-107, 110 compete one against the other using EDCA (Enhanced Distributed Channel Access) contention, to gain access to the communication channel 100 in order to be granted a transmission opportunity (TXOP) and then transmit (single-user, SU) data frames. The stations may also use a multi-user (MU) scheme in which a single station, usually the AP 110, is allowed to schedule a MU transmission, i.e. multiple simultaneous transmissions to or from other stations, during a TXOP granted to the single station (e.g. AP 110). One implementation of such a MU scheme has been for example adopted in IEEE 802.11ax amendment standard, as the Multi-User Uplink and Downlink OFDMA (MU UL and DL OFDMA) procedures.

The non-AP stations may represent various devices such as gaming client, augmented/virtual reality headset, smartphones, wireless display and some of them have to exchange (i.e. transmit or/and receives) low-latency or LLRS traffic over time. LLRS traffic has more constrained QoS requirements regarding for instance PDR, jitter and/or latency, than not-LLRS traffic coexisting in the WLAN 10.

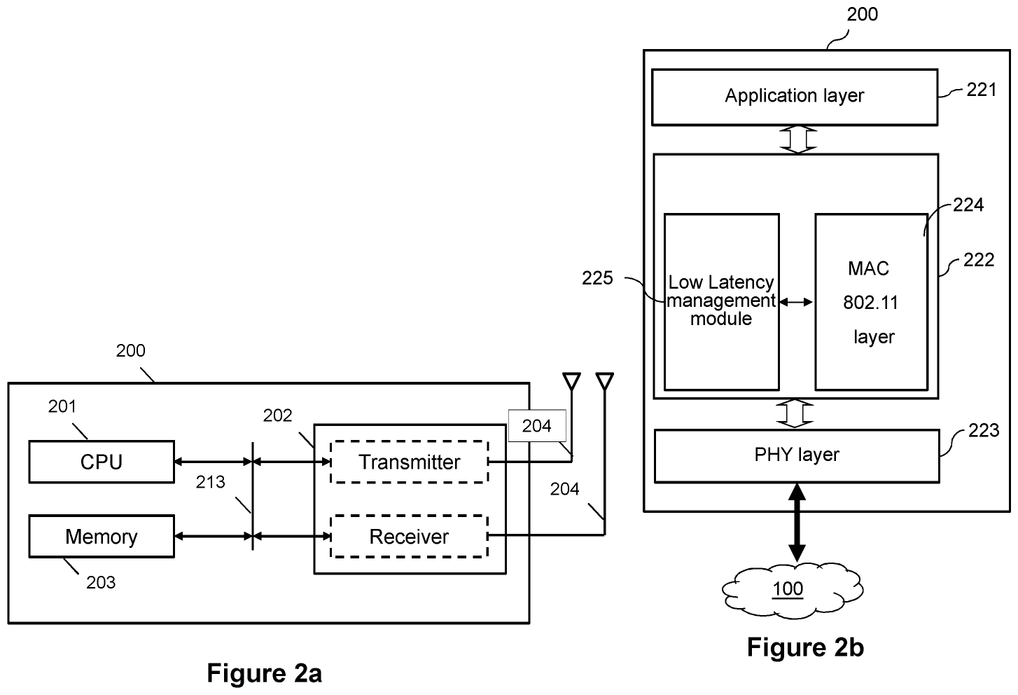

FIG. 2a schematically illustrates a communication device 200, either a non-AP station 101-107 or the access point 110 of network 10, configured to implement at least one embodiment of the present invention. The communication device 200 may preferably be a device such as a micro-computer, a workstation or a light portable device. The communication device 200 comprises a communication bus 213 to which there are preferably connected:

a central processing unit 201, such as a processor, denoted CPU;

a memory 203 for storing an executable code of methods or steps of the methods according to embodiments of the invention as well as the registers adapted to record variables and parameters necessary for implementing the methods; and

at least one communication interface 202 connected to a wireless communication network, for example a communication network according to one of the IEEE 802.11 family of standards, via transmitting and receiving antennas 204.

Preferably the communication bus 213 provides communication and interoperability between the various elements included in the communication device 200 or connected to it. The representation of the bus is not limiting and in particular the central processing unit is operable to communicate instructions to any element of the communication device 200 directly or by means of another element of the communication device 200.

The executable code may be stored in a memory that may either be read only, a hard disk or on a removable digital medium such as for example a disk. According to an optional variant, the executable code of the programs can be received by means of the communication network, via the interface 202, in order to be stored in the memory of the communication device 200 before being executed.

In an embodiment, the device is a programmable apparatus which uses software to implement embodiments of the invention. However, alternatively, embodiments of the present invention may be implemented, totally or partially, in hardware (for example in the form of an Application Specific Integrated Circuit or ASIC).

FIG. 2b is a block diagram schematically illustrating the architecture of the communication device 200, either the AP 110 or one of stations 101-107, adapted to carry out, at least partially, embodiments of the invention. As illustrated, device 200 comprises a physical (PHY) layer block 223, a MAC layer block 222, and an application layer block 221.

The PHY layer block 223 (here for illustration an 802.11 standardized PHY layer) has a task of formatting, modulating on or demodulating frames from any 20 MHz channel or composite channel forming the communication channel 10. The frames may be 802.11 frames. For instance, medium access trigger frames (TFs) to reserve a transmission opportunity and resource units, MAC data and management frames adapted to a 20 MHz width communication channel to interact with legacy 802.11 stations, as well as MAC data frames of OFDMA type having smaller width (typically 2 or 5 MHz) than the 20 MHz legacy width.

The MAC layer block or controller 222 preferably comprises an 802.11 MAC layer 224 implementing conventional 802.11 MAC operations, and an additional block 225, referred to as Low Latency management module, implementing embodiments of the invention (either from non-AP station perspective or from AP perspective). The MAC layer block 222 may optionally be implemented in software, which software is loaded into RAM 203 and executed by CPU 201.

The 802.11 MAC layer 224 and the Low Latency management module 225 interact one with the other in order to process communications addressed to multiple stations according to embodiments of the invention.

On top of the Figure, application layer block 221 runs an application that generates and receives data traffic, such as a video stream. Application layer block 221 represents all the stack layers above MAC layer according to the OSI model.

To prioritize LLRS traffic over not-LLRS traffic within a BSS, a service period (SP) is reserved for LLRS traffic (also referred to as LL SP). The AP schedule the reserved service period and may provide timing information for identifying the service period. The AP may need to announce the starting time and the ending time of the period. The reserved service period may be fully dedicated to LLRS traffic exchange, or in variant may allow both LLRS traffic and not-LLRS traffic.

However, establishing a LL SP (e.g. defining starting/ending times, usage by stations, etc.) requires a dedicated signaling that is costly to implement and may not be backward compatible with existing (legacy) devices.

The invention, in one of its aspects, proposes to address the foregoing concern by leveraging the existing Target Wake Time (TWT) service period and associated protocols, with a dedicated and new signalling. Thus, at a limited cost of an adaptation, the TWT mechanism and its associated protocol can be advantageously used for an efficient handling of Low Latency reliable services.

In embodiments of the invention, the reserved service period is a protected Target Wake Time (TWT) service period (referred to as TWT SP or LL TWT SP or restricted TWT (rTWT) SP).

Target Wake Time enables devices to determine when and how frequently they will wake up to send or receive data. TWT allows an AP to manage activity in the network in order to minimize medium contention between stations (STAs), and to reduce the required amount of time a station in a power-save mode needs to be awake. Thanks to this mechanism, a TWT requesting STA can doze except during the TWT service period (SP) intervals.

TWT SPs can be either individually agreed or broadcast. An individual TWT SP is a specific time or set of times negotiated between two individual stations (referred to as TWT requesting STA and TWT responding STA) and at which the stations are expected to be awake in order to exchange frames with each other. During negotiations, they transmit to each other a special information element (TWT IE) which contains TWT parameters and can be interpreted as request, suggestion, demand, alternation, acceptation, dictation, or rejection. Either the AP or the STA can tear down the TWT by transmitting a TWT Teardown frame. The broadcast TWT is similar to an individual TWT except that the specific time or set of times are not negotiated between stations but directly broadcast by an AP to multiple non-AP stations, e.g. using a beacon frame. In that case, the AP uses another mechanism based on a TIM element to indicate the set of STAs towards which the AP is going to transmit (Downlink data—DL) or which the AP is going to trigger for uplink traffic. If a STA is not indicated in a TIM element, it means that it will not be solicited within the next TWT SP.

During negotiation of an individual TWT SP or a broadcast TWT SP, low latency traffic specifications may be exchanged using a TWT Information Element (IE) according to embodiments of the invention. The traffic specifications may include traffic identifiers (TIDs) and/or a stream classification service identifiers (SCSIDs). These identifiers may be used to prioritize or restrict the traffic streams allowed to be transmitted during the TWT SP.

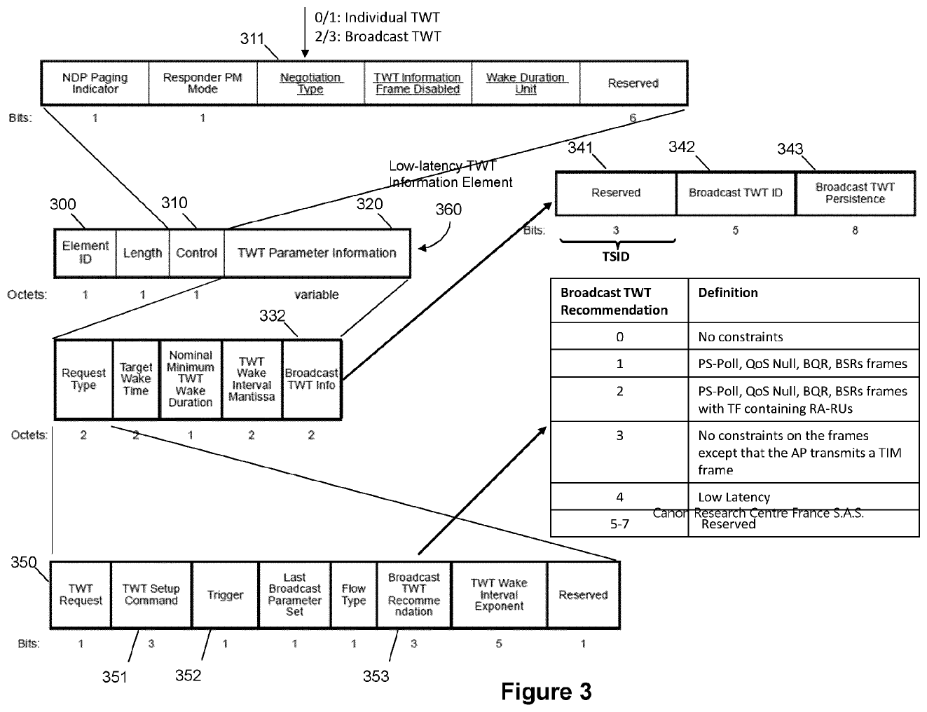

FIG. 3 illustrates signalling implementations for advertising a new low-latency TWT service period in a management frame such as a beacon frame or a probe response frame.

The broadcast TWT may be advertised by the AP using a beacon frame, and the AP uses another mechanism based on TIM element that indicates the set of STAs to which the AP is going to transmit downlink data (DL) or to trigger them for uplink traffic. If a STA is not indicated in a TIM element, it means that it will not be solicited during the next TWT SP.

The TWT parameters are transmitted thanks to a LL TWT Information Element (IE) 360 comprising an Element ID (identifier) field 300, a control field 310 and a TWT Parameter Information field 320. The LL TWT IE is based on a broadcast Information Element described in section 9.4.2.199 in the IEEE 802.11-2020 Standard and adapted for LL traffic handling according to embodiments of the invention. The “Control” field 310 allows to detect a broadcast TWT through the “Negotiation Type” field 311. The MSB bit of this field is set to 1 to promote a broadcast TWT. Next, the TWT scheduling AP sets the “TWT Request” subfield 350 to 0 and the TWT Setup Command subfield 351 as “Accept” to announce the next TWT SP, as “Alternate” to announce the next TWT SP with a new set of TWT parameters and as “Reject” to tear down a broadcast TWT (the ending date is identified in the “Broadcast TWT Persistence” subfield 343). The broadcast TWT IE 360 includes a TWT Parameter information field 320 defining the set of TWT parameters. Each set of TWT parameters is identified by a “Broadcast TWT ID” field 342 allowing an AP to schedule multiple sets of broadcast TWT SPs with different sets of TWT parameters. A STA may request to become a member of a broadcast TWT (i.e. register) by transmitting a frame to its associated AP that contains a TWT element with the “Negotiation Type” subfield 311 set to 3 and the “TWT Setup Command” field 351 set to “Request TWT” or “Suggest TWT” or “Demand TWT”. The Broadcast TWT info 332 indicates the Broadcast TWT ID 342 of the broadcast TWT that the STA is requesting to join. The Trigger field 352 indicates whether or not the TWT SP indicated by the TWT element includes triggering frames.

The “Broadcast TWT Recommendation” field 353 is used in the 802.11 standard to advise STAs to send PS-Poll, QoS Null, BQR or BSR frames when they are solicited by the AP. But it is only a recommendation. If STAs wants to transmit any other kinds of frames, there is no pure restriction.

The low latency services are based on 2 main requirements:
when some low-latency packets have to be transmitted by a STA (e.g. time-sensitive traffic), the STA needs to get the medium access on a precise date; and
to be efficient, the transmission of low-latency frames (e.g. latency-sensitive traffic) needs to be short to give transmission opportunities to many LL STAs and to avoid to penalize heavily all other non-LL STAs.

To fulfill these low latency requirements, it is defined a new value for the “Broadcast TWT recommendation” field 353 dedicated to low latency frames transmission (for instance value=4) according to embodiments of the invention.

In an embodiment, having the field 353 set to this new value, does not mean a recommendation but an obligation for the solicited STA to transmit only low latency traffic. For instance, a low latency packet can be identified by its associated traffic stream identifier (TSID). The 802.11 standard defines 8 values of TSIDs. Optionally, to be more precise, the traffic stream identifier could be identified by using the “Reserved” 3-bit field 341. Another example is that a low latency packet can be a QoS data packet containing low latency traffic, a control and/or a management frame used to configure and update the configuration of low latency traffic. In an embodiment, having the field 353 set to this new value, does not mean a recommendation but an obligation for the solicited STA to transmit low latency traffic in priority. If no packet containing low latency traffic is ready for transmission and some allocated bandwidth remains available, the solicited STA may transmit any other packet ready for transmission.

In other embodiments, having the field 353 set to this new value, does not mean an obligation but a recommendation for the solicited STA to transmit either only low latency traffic or low latency traffic in priority.

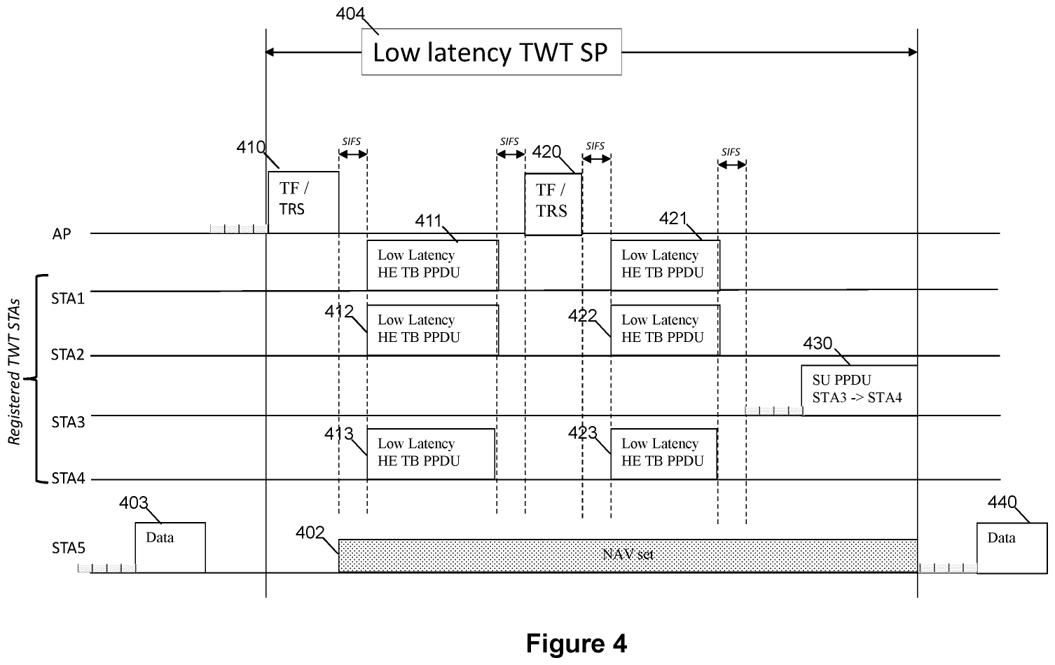

FIG. 4 illustrates an exemplary scenario describing how a low latency TWT service period is executed.

In this exemplary scenario, the AP has already initialized a low-latency broadcast TWT (identified by a broadcast TWT ID and a “broadcast TWT recommendation” field set to “low latency”) for which STA1, STA2, STA3 and STA4 are registered. These registered STAs were solicited to participate the low latency TWT SP 404 upon the reception of a broadcast TWT element as described in FIG. 3. Just before the beginning of the low latency TWT SP, a non-registered STA5 ends its data transmission 403. When the low latency TWT SP starts, the AP is in charge of sending a trigger frame or including a TRS field inside a downlink frame (410). This trigger frame reserves a transmission opportunity with a length at least equal or higher than the length of the low-latency TWT SP. The consequence is that all non-registered STAs sets their NAV time (402) meaning that they will not contend the medium throughout the low latency TWT SP. On the contrary, all registered STAs for this broadcast TWT (identified by a broadcast TWT ID) will not set their NAV time because they will be scheduled through one or multiple trigger frames 410, 420 during the low latency TWT SP. In a variant, the trigger frame reserves a transmission opportunity duration that is only sufficient for the STAs scheduled by the trigger frame to send or receive data, i.e. the transmission opportunity does not necessarily last until at least the end of, or encompass the LL TWT SP. In this case, non-registered STAs are not authorized to communicate during the LL TWT SP even if the communication channel is not reserved or becomes idle within the LL TWT SP. Indeed, a STA may try to access the communication channel directly using EDCA in single user mode, and thus reserves the communication channel for the duration of its transmission without the communication being reserved by the AP, e.g. by means of a trigger frame.

If the scheduling procedure is driven by the AP, the AP announces this scheduling process by setting the “Trigger” field 352 to 1 inside the TWT element previously received.

Optionally, the registered STAs can apply a new set of EDCA parameters, called low latency (LL) EDCA parameters. The LL EDCA parameters are only applied during the low latency TWT SP. The remaining running backoffs are suspended during the low latency TWT SP. They will be restored at the end of the low latency TWT SP. The LL EDCA parameters are defined such as the AP gets the highest medium access priority at the beginning of the low latency TWT SP, for instance by setting an AIFSN value of the STAs higher than the AP's AIFSN. Moreover, the parameters driving the contention window can be optimized to optimize the medium access of the registered STAs if the AP does not transmit trigger frames.

Optionally, the AP may apply a new set of EDCA parameters, in replacement or in addition of the update of the EDCA parameters by the registered STAs, to get priority to access the communication channel over the registered STAs. For instance, the AP may set an AIFSN value lower than the AIFSN of the STAs.

When the registered STAs are scheduled, they send, in response, a trigger-based (TB) physical protocol data unit (PPDU) (411,412,413, 421,422,423). The TB PPDU is a frame transmitted in a resource unit reserved by a trigger frame. In an embodiment, the TB PPDU contains only low-latency traffic, for which the TSID can be optionally mentioned in the “reserved” field 341. In another embodiment, the TB PPDU contains low latency traffic and non-LL traffic to be transmitted by the STA.

Optionally, the AP may also let the medium free for some registered LL STAs that have some peer-to-peer low-latency traffic to exchange with some other registered STAs (430) in single user (SU) mode. At the end of the low latency TWT SP, the medium becomes available for contention by all STAs of the 802.11 BSS, for instance STA5 may send a PPDU (440) after the LL TWT SP.

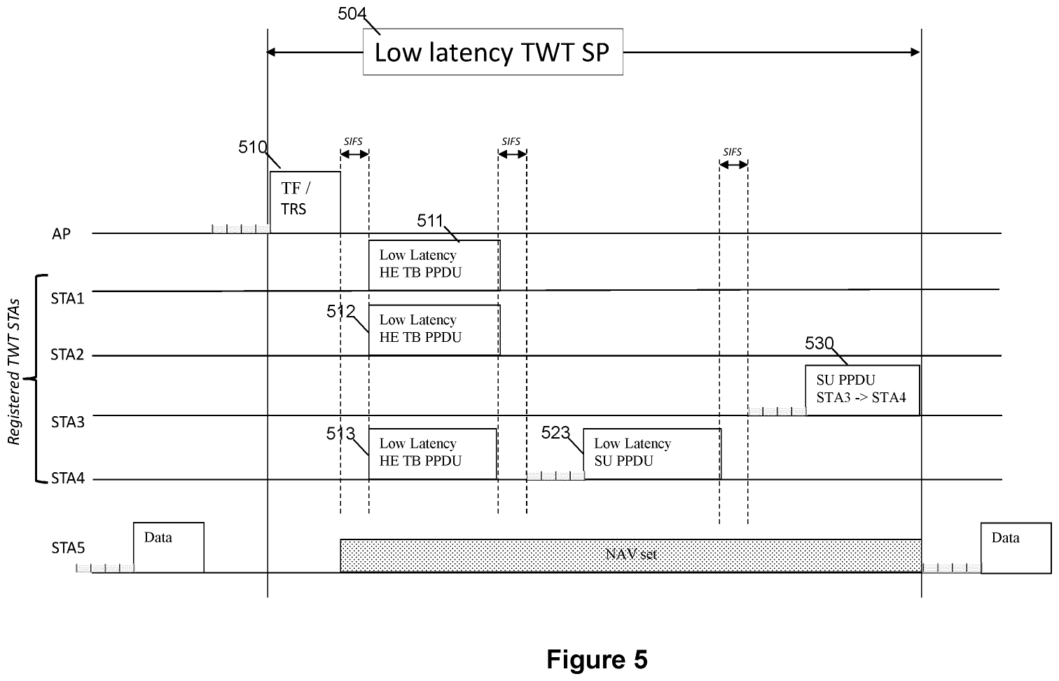

FIG. 5 illustrates a secondary exemplary scenario describing how a low latency TWT service period is executed;

In this exemplary scenario, the AP has already initialized a low-latency broadcast TWT (identified by a broadcast TWT ID and a “broadcast TWT recommendation” field set to “low latency”) for which STA1, STA2, STA3 and STA4 are registered. These registered STAs were solicited to participate the low latency TWT SP 504 upon the reception of a broadcast TWT element as described in FIG. 3. The main difference with the previous scenario is that the AP sends only one trigger frame or includes a TRS field inside a downlink frame (510) at the beginning of the low latency TWT SP. This trigger frame reserves a transmission opportunity with a length at least equal or higher than the length of the low-latency TWT SP. Alternatively, and as discussed in the description of FIG. 4, the trigger frame may reserve a transmission opportunity only for the transmission of TB PPDUs and not necessarily for all the duration of the TWT SP. In either case, all non-registered STAs sets their NAV time meaning that they will not contend the medium throughout the low latency TWT SP. It has to be noticed that the NAV time is set based on the “Duration” field of the MAC header. Then the AP can send a trigger frame to schedule registered STAs for a short period of time by setting the “UL length” field in the “Common Info” field of the Trigger frame to this short period of time. The AP warns that it will not send other trigger frames by setting the “More TF” subfield in the “Common Info” field of the Trigger frame to 0. Then the scheduled STAs sends in response a TB PPDU (511,512,513). In an embodiment, these TB PPDUs contain only low-latency traffic, for which the TSID can be optionally mentioned in the “reserved” field 341. In another embodiment, the TB PPDUs contain low latency traffic and non-LL traffic.

Following this data exchange, registered STAs contend the medium to transmit frames comprising low-latency traffic (523, 530), for which the TSID can be optionally mentioned in the “reserved” field 341. These frames may be transmitted in single user mode. Optionally, these registered STAs may apply a new set of EDCA parameters, called low latency (LL) EDCA parameters. This is the same procedure as in the description of FIG. 4.

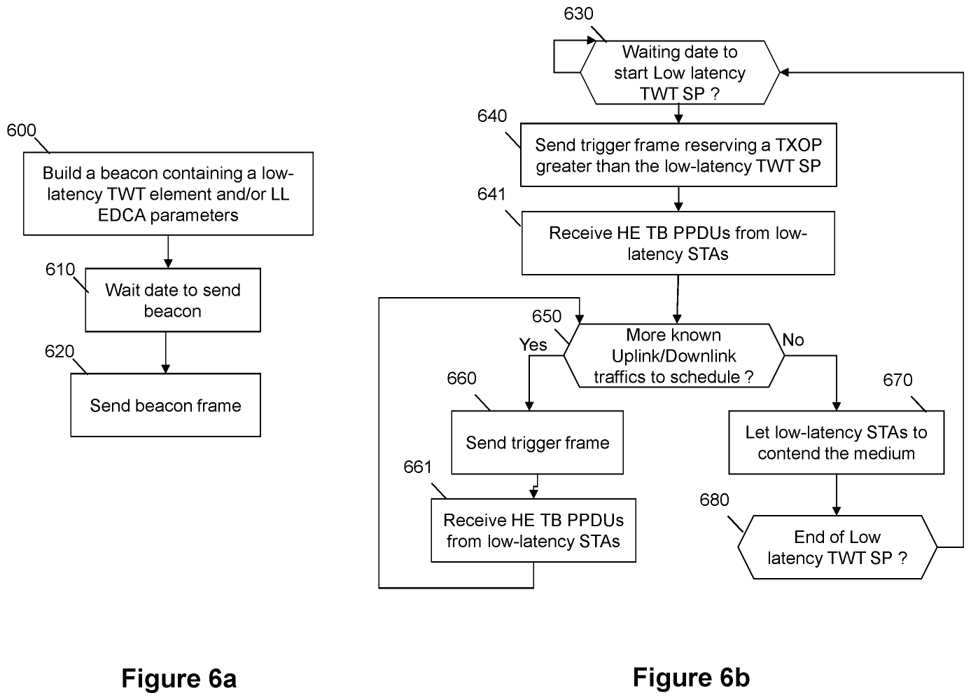

FIGS. 6a and 6b illustrate, using a flowchart, general steps at an AP station according to embodiments of the invention.

FIG. 6a is an algorithm describing the sending of a low latency TWT element in a beacon frame, that is the most common process to announce the next TWT SP. Any other management frame can be used.

At step 600, the AP generates (builds) a beacon frame containing a low-latency TWT element and/or LL EDCA parameters. At step 610, the AP waits a date for sending the beacon frame (620). Step 610 may correspond to the waiting time necessary for the AP to get granted access to the communication channel after the beacon frame is generated.

FIG. 6b describes the behaviour of the AP during the low latency TWT SP. Upon the beginning of the low latency SP (630), the AP contends the medium and sends a trigger frame reserving a transmission opportunity with a length at least equal or higher than the length of the low-latency TWT SP (640). Upon the reception of a TB PPDU in response to the trigger frame (641), the AP may send downlink (DL) frames to registered STAs or further trigger frames to schedule registered STAs for uplink traffic (650, 660, 661). If no transmissions are scheduled by the AP, the AP may let the registered STAs contend the medium for transmitting data packets comprising low latency traffic (670), until the end of the LL TWT SP is reached (680).

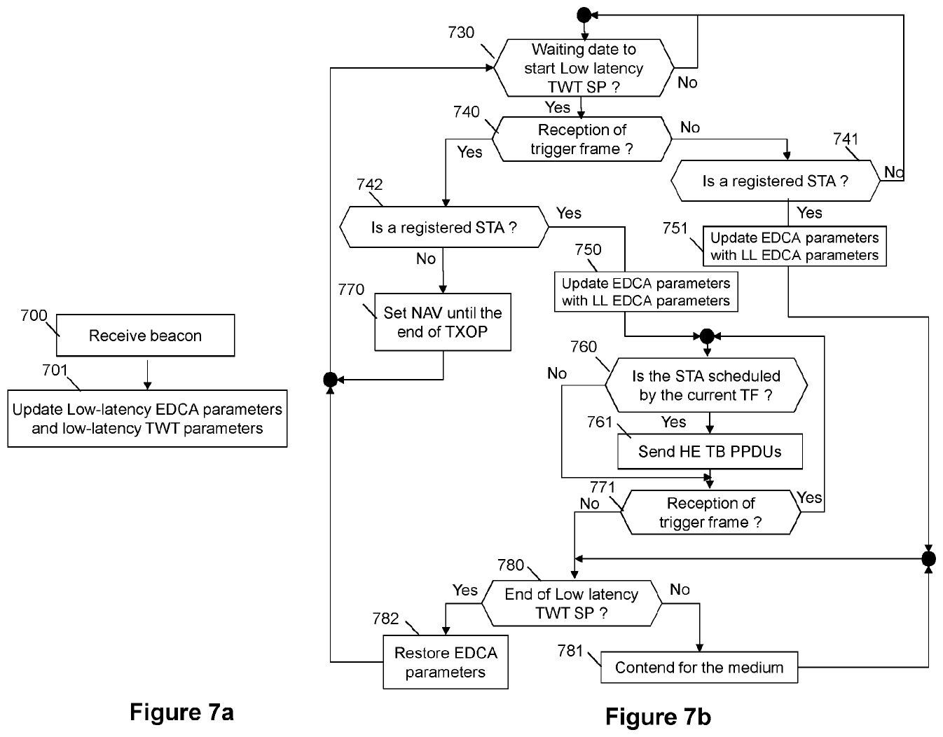

FIGS. 7a and 7b illustrate, using a flowchart, general steps at a non-AP station according to embodiments of the invention.

FIG. 7a is an algorithm describing the reception of a low latency TWT element and optionally the LL EDCA parameters in a beacon frame (700), that is the most common process to announce the next TWT SP. Any other management frame can be used. The station then updates it local parameters with the information received from the AP (701) during the LL TWT SP. The parameters define the behaviour of the registered STAs to contend the medium during the low latency TWT SP and the type of data packets that can be exchanged during the low latency TWT SP. The EDCA parameters received from the AP may include LL EDCA parameters adapted for usage during the LL TWT SP (e.g. leading to a higher priority access) or default EDCA parameters not specifically adapted for the LL TWT SP.

FIG. 7b describes a behaviour of a STA during a low latency TWT SP.

Inside the low TWT latency SP (following its starting date, 730), upon the reception of the trigger frame (740), if the STA is not registered to the corresponding broadcast TWT (identified by its broadcast TWT ID) (742), the STA sets its NAV time with the value of the “Duration” field of the MAC header (770) until the end of the TXOP reserved by the trigger frame. The STA will not contend the medium as long as its NAV time is set and the channel is not idle. Note that the STA's NAV may further be set due to a TXOP reservation by a frame transmitted by another STA that has successfully accessed the medium. Thus, the STA may not be able to access the medium until the end of the low latency TWT SP, particularly if registered STAs apply different (LL) contention (EDCA) parameters values that increase chances to get access to the medium relatively to default contention (EDCA) parameters values applied by the (non-registered) STA.

If the STA is registered to the corresponding broadcast TWT (742) and a trigger frame is received (740), the EDCA parameters are updated to new EDCA parameters (referred to as LL EDCA parameters) that increase the likelihood of access to the medium (750). These LL EDCA parameters may be used after the end of the TXOP reserved by the trigger frame and before the end of the LL TWT SP (780) for the registered station to contend access to the medium (781).

Following the determining that a trigger frame is received by the STA (740 positive) and the STA is registered to the corresponding broadcast TWT (identified by its broadcast TWT ID) (742), each time the STA is scheduled by the AP (760) through a trigger frame (currently received at 740, or subsequently received at 771), it sends in response a TB PPDU containing low latency traffic (761). If no trigger frames are received (771 negative) and if the low latency TWT SP is not ended (780 negative), the STA optionally resumes the remaining running backoffs before applying the new LL EDCA parameters (750) and may contend using the LL EDCA parameters and transmit low latency packets to the AP or other registered STAs (peer-to-peer data) (781). At the end of the low latency TWT SP, the STA restores the default EDCA parameters and the associated backoffs are resumed (782). The STA waits for another low latency TWT SP (730).

If no trigger frame is received by the STA (740 negative) and if the STA is registered to the corresponding broadcast TWT (741 positive), the EDCA parameters are updated (751) similarly to step 750. Then, if the LL TWT SP is not ended (780 negative), the STA optionally resumes the remaining running backoffs before applying the new LL EDCA parameters (751) and may contend using the LL EDCA parameters and transmit low latency frames to the AP or other registered STAs (peer-to-peer data) (781).

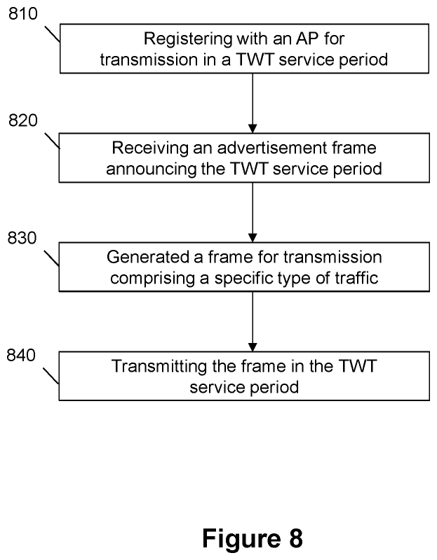

FIG. 8 illustrates, using a flowchart, general steps at a non-AP station according to embodiments of the invention.

At step 810, the station registers with an AP for transmitting frames during a Target Wake Time, TWT, service period. The TWT SP is setup between the station and the AP by means of a setup procedure, for example as described in relation with FIG. 3. The frames to be transmitted comprise in priority a type of traffic specified during the setup procedure of the TWT service period (e.g. time-sensitive traffic, latency-sensitive traffic). Traffic streams are hence prioritized and/or restricted for transmission in a TWT SP (referred to as discussed above as LL TWT SP or restricted TWT (rTWT) SP). The prioritization or the restriction may be based on their traffic identifiers (TIDs), traffic stream identifier (TSIDs) or stream classification service identifiers (SCSIDs).

At step 820, the station may receive from the AP an advertisement frame announcing the rTWT SP. The frame may contain the “Broadcast TWT Recommendation” field 353 indicating the type of traffic for which the rTWT SP is dedicated.

At step 830, the station generates a frame for transmission, and the generated frame is transmitted in the rTWT service period, wherein the frame comprises in priority a type of traffic specified during the setup of the rTWT service period (840).

The generation of the frame may include determining data (e.g. MAC Service Data Units, MSDUs) available (pending) for transmission in the transmission buffers or access categories (ACs), and deciding based on the type of traffic they contain for generating the frame. The deciding may depend on the timing of the expected frame transmission and the type of traffic specified during the setup procedure of the rTWT SP (implicit signaling). It may depend on whether a transmission opportunity is granted by the AP by means of a trigger frame, which may also contain indications on a type of traffic recommended for transmission in a resource unit allocated by the trigger frame, such as “preferred AC” subfield or a SCSID according to IEEE 802.11 (explicit signaling). The deciding may depend on whether the station contends for access using EDCA and whether a granted TXOP overlaps or encompasses the rTWT SP.

In an embodiment, the generated frame comprises the specified type of traffic if the expected transmission time overlaps with the rTWT service period.

Overlapping with the TWT service period may comprise: 1) transmission time starts within the TWT SP and ends after the end of the TWT SP; 2) transmission time starts and ends within the TWT SP (i.e. the TWT SP encompasses the transmission duration); 3) transmission time starts prior the start of the TWT SP and ends within the TWT SP; or 4) transmission time starts prior the start of the TWT SP and ends after the end of the TWT SP (i.e. the transmission duration encompasses the TWT SP).

In an embodiment, the station (rTWT scheduled STA) that received a trigger frame addressed to it with an expected PPDU transmission time overlapping an announced rTWT SP, may select pending MSDUs in the following order.
First, any and all pending MSDUs that correspond to the traffic specified, for the announced rTWT Service Period, during rTWT setup procedure between the rTWT scheduled STA and the rTWT scheduling AP.
Then, any and all pending MSDUs that correspond to any latency sensitive traffic not specified during the rTWT setup procedure.
Then Pending MSDUs of ACs corresponding to the <preferred AC> subfield.
Then Pending MSDUs of other ACs, if any.

In an embodiment, the station (rTWT scheduled STA) that obtains a TXOP overlapping an announced rTWT SP, may select for transmission pending MSDUs in the following order.
First, any and all pending MSDUs that belong to the traffic specified, for the announced rTWT Service Period, during rTWT setup procedure between the rTWT scheduled STA and the rTWT scheduling STA.
Then, any and all pending MSDUs that correspond to any latency sensitive traffic not specified during the rTWT setup procedure.
Then Pending MSDUs of primary AC.
Then Pending MSDUs of other ACs, if any.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1-3. (canceled)

4. A method for wireless communications comprising, at a station:
registering the station with an access point (AP) for transmitting frames during a Target Wake Time (TWT) service period setup between the station and the AP;
receiving, from the AP, an advertisement frame announcing the TWT service period;
receiving, from the AP, a trigger frame allocating a resource unit (RU) within the TWT service period for the station to send a frame; and
transmitting the frame in the TWT service period using the allocated resource unit, wherein the frame comprises in priority a type of traffic specified during the setup of the TWT service period.

5. The method of claim 4, wherein the frame comprising the specified type of traffic is generated for transmission if the expected transmission time overlaps with the TWT service period.

6. (canceled)

7. The method of claim 4, wherein the trigger frame reserves a transmission opportunity, TXOP, overlapping or encompassing the TWT service period.

8. The method of claim 4, wherein the specified traffic type is low latency, LL, traffic.

9. The method of claim 8, wherein the LL traffic includes one or more of time-sensitive traffic and latency-sensitive traffic.

10. The method of claim 4, wherein the transmitted frame further comprises at least one of the following types of traffic:
low-latency traffic not specified during the setup of the TWT service period;
traffic type corresponding to a preferred access category, AC, indicated in a trigger frame allocating a resource unit, RU, within the TWT service period for the station to transmit the frame; or
traffic type corresponding to any AC.

11. The method of claim 4, further comprising contending for access to a communication channel in the TWT service period in order to transmit the frame.

12. The method of claim 11, wherein the contending uses an enhanced distributed channel access, EDCA, mechanism based on EDCA parameters.

13. The method of claim 12, wherein the EDCA parameters are set to first values, different from second values that may be used for contending for access outside the service period.

14. The method of claim 4, wherein the advertisement frame announcing the service period includes a field that specifies the type of traffic to be used in priority during the TWT service period.

15. The method of claim 4, wherein the advertisement frame announcing the service period includes timing information identifying the TWT service period.

16. The method of claim 4, wherein the advertisement frame announcing the service period is a management frame, such as a beacon frame or a probe response frame.

17. The method of claim 4, wherein the TWT service period is an individual TWT negotiated between the station and the AP.

18. The method of claim 4, wherein the TWT service period is a broadcast TWT advertised by the AP.

19. The method of claim 4, wherein, following the registering, the station does not set its Network Allocator Vector, NAV, during the service period.

20. A wireless communication station device, comprising:
a processor configured for:
registering the station with an access point (AP) for transmitting frames during a Target Wake Time (TWT) service period setup between the station and the AP;
receiving, from the AP, an advertisement frame announcing the TWT service period;
receiving, from the AP, a trigger frame allocating a resource unit (RU) within the TWT service period for the station to send a frame; and
transmitting the frame in the TWT service period using the allocated resource unit, wherein the frame comprises in priority a type of traffic specified during the setup of the TWT service period.

21. (canceled)

22. A non-transitory computer-readable medium storing a program which, when executed by a microprocessor or computer system in a wireless device, causes the wireless device to perform the method of claim 4.
